(19) United States
(12) Patent Application Publication
(10) Pub. No.: US 2018/0241624 A1
(43) Pub. Date: Aug. 23, 2018

(54) VIRTUAL DEDICATED NETWORK AND RULE TABLE GENERATION METHOD AND APPARATUS, AND ROUTING METHOD

(71) Applicant: Alibaba Group Holding Limited, Grand Cayman (KY)

(72) Inventors: Chenghao Sun, Hangzhou (CN); Biao Lyu, Hangzhou (CN); Baochun Liu, Hangzhou (CN); Lilong Deng, Hangzhou (CN); Han Xiao, Hangzhou (CN)

(21) Appl. No.: 15/900,410

(22) Filed: Feb. 20, 2018

(30) Foreign Application Priority Data
Feb. 21, 2017 (CN) 201710092684.6

(51) Int. Cl. H04L 12/24; G06F 9/455

(52) U.S. Cl. CPC H04L 41/0806; H04L 41/5054; G06F 2009/45595; G06F 9/45558; H04L 41/5096

(57) ABSTRACT

A method and an apparatus of generating rule tables for a virtual dedicated network, and a routing method are disclosed. The method includes determining virtual switches which act as switching nodes in a virtual dedicated network based on topological structure information of the virtual dedicated network; and using network identifiers of the virtual switches as keywords to configure and generate rule tables of the virtual dedicated network, the rule tables including at least the keywords which act as addresses of the switching nodes in the rule tables. The embodiments of the present disclosure can greatly reduce the number of table items in a rule table in a virtual dedicated network, and reduce the number of table items of transfer nodes and an amount of data of management and control nodes, thus effectively improving the system performance.

### CROSS REFERENCE TO RELATED PATENT APPLICATIONS

This application claims foreign priority to Chinese Patent Application No. 201710092684.6, filed on Feb. 21, 2017, entitled “Virtual Dedicated Network and Rule Table Generation Method and Apparatus, and Routing Method,” which is hereby incorporated by reference in its entirety.

### TECHNICAL FIELD

The present application relates to the technological field of computer data processing, and particularly to virtual dedicated network and rule table generation methods and apparatuses, and routing methods.

### BACKGROUND

Virtual Private Cloud (VPC) is a private cloud platform that is implemented based on virtualization technologies and is provided to a company for use. The VPC groups a series of virtual resources such as a network, security, storage, and computation, and provides secure and convenient IT service applications to company users for use according to needs. Along with centralization of data centers, an increasing number of large-scale companies tend to use virtual private clouds for deploying company internal IT systems.

A virtual private cloud service provider can construct an isolated and self-defined virtual dedicated network (i.e., a subnet of a virtual private cloud). Generally, a subnet includes a number of management/control rule tables, such as a routing table, a security policy table, an address translation table, etc. These rule tables may store configuration and processing policies of the virtual dedicated network. These rule tables can be used for implementing node control such as IP address assignment, segment division, routing rule setting, gridding, etc., and allowing a user to control a virtual dedicated network thereof according to resource requirements. In general, for a virtual dedicated cloud service provider, VPC products amount to providing a self-defined network for each user. In these self-defined networks, various types of entity concepts, such as routers, switches, safety devices, interfaces, etc., in a conventional network are needed to be abstracted for the users. Table entries such as various types of rule concepts, routing tables, security policy tables, network address translation tables, etc., are also needed to be abstracted. However, along with the continuous development of virtualization technologies and a continuous increase in single virtual machine ratio, user requirements for virtualization capabilities of single clusters have become higher, and the need of migration into virtual private clouds for users has increased. Currently, especially for large-scale users (such as political or industry customers, bank customers and Internet customers, etc.), such users need virtual private clouds having higher security, performance and automated network capabilities. Therefore, when a number of users of virtual private clouds reach an exceedingly large scale and networks of certain user clouds reach an exceedingly large scale, data volume of these rule tables become extremely large correspondingly, thereby affecting the processing performance and capacity of an entire system.

For example, a virtual dedicated network of a user is assumed to include 1000 VM (VMware or virtual machines) and three rule tables (a routing table, a security policy table and a NAT table) are used. Each VM is included in the rule tables, and each table includes 1000 table items. If one million of such users exist, a scale of single table items is one billion. Such large amount of table items will cause an exceedingly large scale of table items in transfer nodes, and increase the workload of memory for storing such tremendous amount of table items, thus reducing the speed of searches and updates, and decreasing the throughput of the entire entity. Furthermore, the workload of managing table items during node management and control is increased, and the performance of a system will be affected by various types of operations such as maintenance, issuing, verification, and refreshing, etc., due to a huge number of updates or downloads, thus reducing the product usage experience of users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer readable instructions as permitted by the context above and throughout the present disclosure.

The goals of the present disclosure are to provide a method and an apparatus of generating rule tables for a virtual dedicated network, and a routing method, which can greatly reduce a number of table items in the virtual dedicated network, reduce data volumes of transfer node table items and management and control nodes, improve the performance of an entire system, and reduce the complexity of the system. The disclosed method and apparatus can effectively solve the scaling, performance and capacity issues associated with a virtual dedicated network having a tremendous amount of users.

A method and an apparatus of generating rule tables for a virtual dedicated network, and a routing method provided in the present disclosure are implemented as follows.

A method of generating rule tables for a virtual dedicated network includes determining virtual switches which act as switching nodes in a virtual dedicated network based on topological structure information of the virtual dedicated network; and using network identifiers of the virtual switches as keywords to configure and generate rule tables of the virtual dedicated network, the rule tables including at least the keywords which act as addresses of the switching nodes in the rule tables.

Computer readable media stores computer instructions. When the computer instructions are executed, the following operations are implemented: determining virtual switches which act as switching nodes in a virtual dedicated network based on topological structure information of the virtual dedicated network; and using network identifiers of the virtual switches as keywords to configure and generate rule tables of the virtual dedicated network, the rule tables including at least the keywords which act as addresses of the switching nodes in the rule tables.

A routing method for a virtual dedicated network, includes analyzing a network message that is received, determining a target host computer to which the network message is jumped, and obtaining a target host computer identifier of a virtual switch corresponding to the target host computer; querying a routing address of a virtual switch that is next to be jumped into in a route towards the target host computer from a routing rule table based on the target network identifier, the routing rule table including at least the network identifier of the virtual switch that is used as the routing address configured and generated in the routing rule table; and sending the network message to the virtual switch that is next to be jumped into based on the routing address.

Computer readable media stores computer instructions. When the computer instructions are executed, the following operations are implemented: analyzing a network message that is received, determining a target host computer to which the network message is jumped, and obtaining a target host computer identifier of a virtual switch corresponding to the target host computer; querying a routing address of a virtual switch that is next to be jumped into in a route towards the target host computer from a routing rule table based on the target network identifier, the routing rule table including at least the network identifier of the machine virtual switch that is used as the routing address configured and generated in the routing rule table; and sending the network message to the virtual switch that is next to be jumped into based on the routing address.

An apparatus of generating rule tables for a virtual dedicated network includes a node determination module used for determining virtual switches which act as switching nodes in a virtual dedicated network based on topological structure information of the virtual dedicated network; and a rule table configuration module used for using network identifiers of the virtual switches as keywords to configure and generate rule tables of the virtual dedicated network, the rule tables including at least the keywords which act as addresses of the switching nodes in the rule tables.

A virtual dedicated network includes at least virtual switches, subnets that use the virtual switches act switching nodes, and rule tables that store configuration and processing policies of the virtual dedicated network. The rule tables are configured to be generated by using the foregoing method of generating rule tables for a virtual dedicated network, or generated by the foregoing apparatus of generating rule tables for a virtual dedicated network.

The method and the apparatus of generating rule tables for a virtual dedicated network provided in the present disclosure can configure and generate a variety of rule tables such as a security policy table and a routing table for virtual switches. The number of table items in the variety of rule tables can be greatly reduced because the number of virtual switches is generally much less than the number of switching nodes. As such, since the number of table items in the rule tables is greatly reduced, the number of table items processed by switching (transfer) nodes is thus reduced. Therefore, the speeds of updates and queries are increased, and the entire throughput is increased, thereby improving the performance of a system and reducing the complexity of the system. For node management and control, a number of updates and downloads are apparently reduced, and thereby the system can easily support a tremendous number of users. The capacity of the system is also easily expanded and increased. By using embodiments of the present disclosure for generating rule tables, the consumption of resources can be effectively reduced, and the performance and the usage experience of a network is improved. Moreover, the costs for managing and maintaining security policy tables can also be reduced.

### BRIEF DESCRIPTION OF THE DRAWINGS

In order to describe technical solutions of the embodiments of the present disclosure in a better manner, accompanying figures that are needed for describing the embodiments are briefly described herein. Apparently, the described figures merely represent some embodiments recorded in the present disclosure. Based on these embodiments, one skilled in the art can obtain other figures without making any creative effort.

FIG. 1 is a flowchart of a method of generating rule tables for a virtual dedicated network in accordance with an embodiment of the present disclosure.

FIG. 2 is a schematic diagram of an entire logical structure of a VPC used by a certain VPC service provider in existing technologies.

FIG. 3 is a schematic diagram of a topological structure of a virtual dedicated network in accordance with the present disclosure.

FIG. 4 is a schematic diagram of a modular structure of an apparatus of generating rule tables for a virtual dedicated network in accordance with an embodiment of the present disclosure.

FIG. 5 is a schematic diagram of a transfer of a message using a virtual switch as a keyword in a virtual dedicated network in accordance with the present disclosure.

### DETAILED DESCRIPTION

In order to enable one skilled in the art to understand the technical solutions of the present disclosure in a better manner, the technical solutions of the embodiments of the present disclosure are described in a clear and complete manner in conjunction with the accompanying figures. Apparently, the described embodiments merely represent some and not all of the embodiments of the present disclosure. Based on the embodiments of the present disclosure, all the other embodiments that are obtained by one of ordinary skill in the art without making any creative effort shall fall in the scope of protection of the present disclosure.

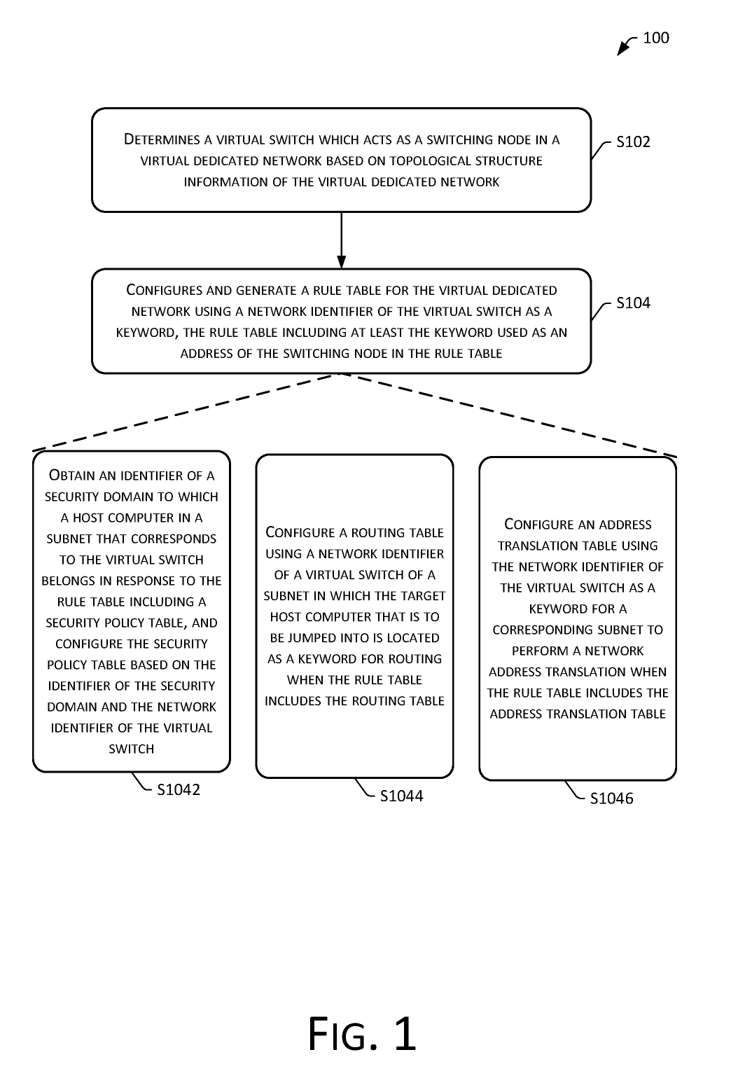

FIG. 1 is a flowchart of a method of generating rule tables for a virtual dedicated network in accordance with an embodiment of the present disclosure. Although the present disclosure provides method operations or apparatus structures as shown in the following embodiments or the accompanying drawings, the methods or apparatuses may include a combination of more or fewer operations or modular units due to conventional or non-creative effort. The operations or structures do not logically have any necessary causal relationships, and orders of execution of these operations or module structures of the apparatuses are not limited to execution orders or module structures shown in the implementations or drawings of the present disclosure. When an apparatus or a terminal of the method or module structure is used in practice, a sequential or parallel execution (e.g., parallel processor or multithreaded environment and even distributed process execution environment) may be performed according to the method or module structure shown in the embodiments or the accompanying figures.

In a physical network, rule tables, such as a routing table, a security policy table and an address translation table, generally use IP addresses or host computer names of host computers for performing configuration. Virtual private networks in existing technologies also use this kind of approach. In virtual dedicated networks, virtual dedicated networks among users are isolated from one another. Generally, a subnet includes a number of management/control rule tables such as a routing table, a security policy table, an address translation table, for example. Node control such as IP address assignment, segment division, routing rule setting and gridding can be implemented, to enable a user to control a virtual dedicated network thereof according to resource requirements.

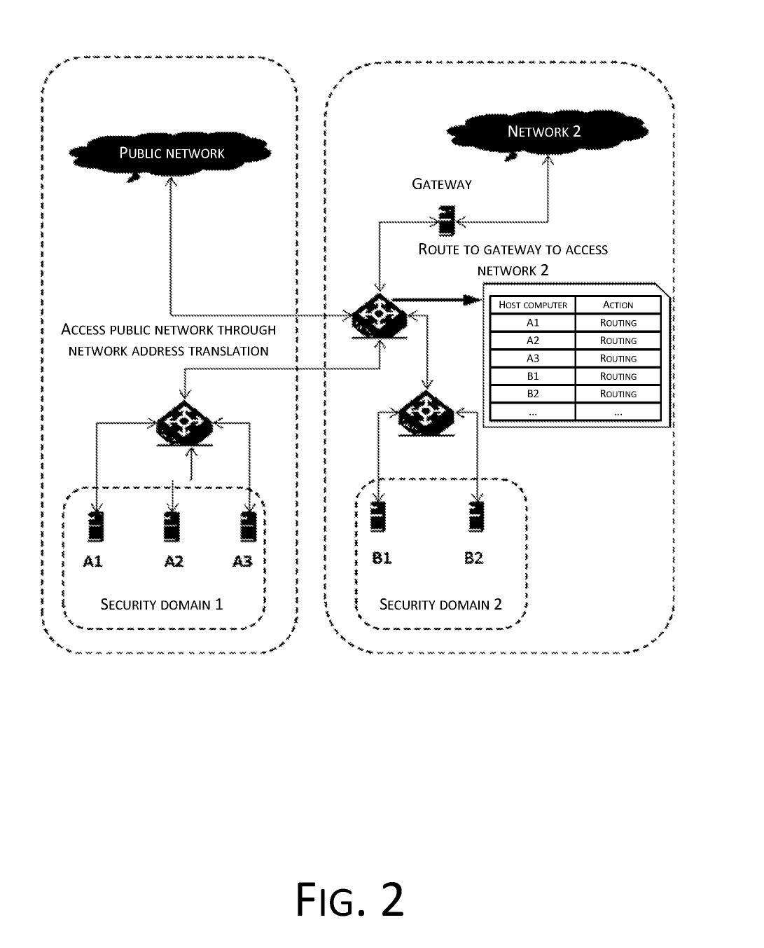

VPC may be understood as a software-defined network, implementing an optimization of moving in, moving out and migrating across AWS regions in enterprise applications. In general, VPC architecture usually includes three important components—switches, gateways and controllers. FIG. 2 shows a schematic diagram of an entire logical structure of a VPC used by a certain VPC service provider in existing technologies. Switches (physical machines and virtual machines) and gateways form a key route of a data path. A controller broadcasts transfers to the gateways and the switches using a protocol, to complete a key route of a configured path. The configured path and the data path are isolated with each other in an entire architecture. Switches can be distributed nodes, and can implement management and control of tens of thousands of virtual networks based on a SDN protocol and controller(s). For a service provider of virtual dedicated networks, VPC products amount to providing a self-defined network to each user. In these self-defined networks, various types of entity concepts, such as routers, switches, safety devices, interfaces, etc., in a conventional network are needed to be abstracted for the users. Table entries such as various types of rule concepts, routing tables, security policy tables, network address translation tables, etc., are also needed to be abstracted. For example, FIG. 2 shows a schematic diagram of an entire logical structure of a VPC used by a certain VPC service provider in existing technologies. Content of configuration of some rule tables in an existing VPC network can be represented as follows:

TABLE 1
Security Policy Table

| Host Computer | Security domain |
|---|---|
| A1 | 1 |
| A2 | 1 |
| A3 | 1 |
| A4 | 2 |
| A5 | 2 |

TABLE 2
Routing Table and Address translation Table

| Host Computer | Action |
|---|---|
| A1 | Address translation |
| A2 | Address translation |
| A3 | Address translation |
| A1 | Routing |
| A2 | Routing |
| A3 | Routing |
| B1 | Routing |
| B2 | Routing |
| . . . | . . . |

Apparently, the routing table and the address translation table in Table 2 can be separate and independent rule tables. The routing table can be configured with information including host computers and routing and transmission information of messages, etc.

The virtual dedicated network described in the present disclosure defines virtual switches such as switches, which are usually called as virtual switches. For a virtual dedicated network, the present disclosure separately improves specific keywords of rule tables such as a routing table, a security table and a network address translation table, and expands the use of simple IP addresses and host computers as keywords to the use of virtual switches as keywords for setting up policies. The present disclosure provides another design solution for rules such as a transfer table and a policy table in a virtual network, and is able to greatly reduce the number of rule tables in a virtual dedicated network and an amount of data of the rule tables, leading to an improvement in a performance index of transfer nodes and management and control nodes, and a reduction in the complexity of a network system. The present disclosure can effectively support virtual dedicated networks having a large amount of throughput, and improve the system capacity and the user experience. As shown in an example of FIG. 1, the present disclosure provides an exemplary method 100 of generating rule tables for a virtual dedicated network, and may include the following operations.

S102 determines a virtual switch which acts as a switching node in a virtual dedicated network based on topological structure information of the virtual dedicated network.

S104 configures and generates a rule table for the virtual dedicated network using a network identifier of the virtual switch as a keyword, the rule table including at least the keyword used as an address of the switching node in the rule table.

In general, a subnet may include one or more virtual switches, and a virtual switch can only be included in one subnet. Different subnets can be distinguished, and each subnet can include one or more host computers (virtual machines). In an application scenario of a virtual dedicated network of the present disclosure, a subnet can be allowed to have only one virtual switch. Using a keyword as an address of a switching node in a rule table can be understood as an existence of at least one network identifier of a virtual switch being used as the address of the switching node in the routing table among rule tables in a virtual dedicated network. For example, a target address to be jumped in an existing routing table is generally an IP address, such as 192.168.10.100. In implementations of the present disclosure, a routing table that is generated can include a virtual switch of a subnet as an address to which a transfer is to be made, for example, a host computer of 192.168.10.100 in a subnet 10. A network identifier of virtual switch of the subnet 10 is S10, and so a routing table can set a jump to S10. By analyzing a message, a virtual switch can know information of a subnet in which a target host computer of a message is located, e.g., a subnet serial number or a network identifier of a virtual switch, and determine that 192.168.10.100 belongs to S10. As such, a jump can be made directly to a next jump address according to the routing table of the present disclosure. If the subnet 10 includes 100 host computers, transmission of all messages that need to be routed to S10 to a next jump can be implemented by merely setting routing data in a routing table of a virtual switch, thus greatly reducing table items in the routing table. For an example of a virtual dedicated network, the virtual dedicated network includes two virtual switches and two groups, i.e., a virtual switch 1 and a virtual switch 2, and a subnet 1 and a subnet 2. The virtual switch 1 is allocated in the subnet 1, and the virtual switch 2 is allocated in the subnet 2. A network identifier of the virtual switch 2 is set to be S1, and a network identifier of the virtual switch 2 is set to be 2. The subnet 1 is recorded as Group 1, and the subnet 2 is recorded as Group 2. In this virtual dedicated network, S1 is actually a virtual switch, and S2 is similar a virtual switch. If a subnet is used for setting a group of security domains, in an application scenario of the present disclosure,

Group 1 can be represented as:

S1 belongs to Security Group 1, indicating that the virtual switch is included (or belongs to) Group 1.

Group 2 can be represented as:

S2 belongs to Security Group 2, indicating that the virtual switch is included (or belongs to) Group 2.

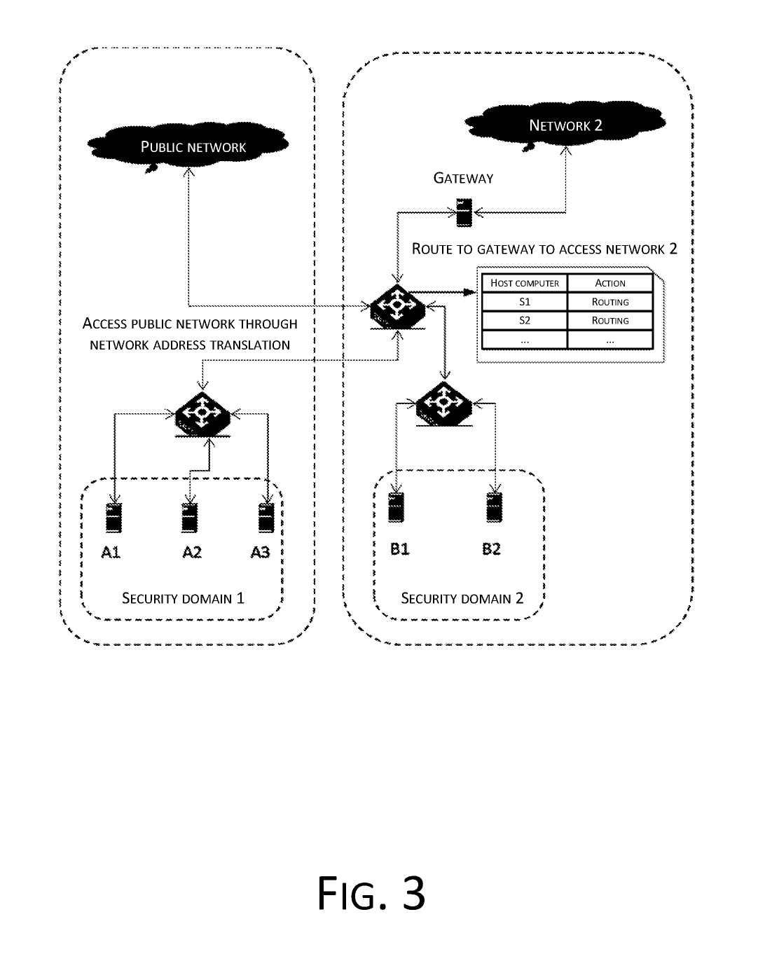

The embodiments of the present disclosure can use network identifiers of virtual switches in a virtual dedicated network, such as S1, S2, etc., as keywords in rule tables for setting up the rule tables to implement corresponding configuration policies. An application scenario is shown in FIG. 3. FIG. 2 is a schematic diagram of a topological structure of a virtual dedicated network in accordance with the present disclosure. A topological structure of a virtual dedicated cloud according to an embodiment of FIG. 3 is similar to the network topological structure of FIG. 2. However, details of a rule table are changed in a way as follows:

The virtual switch S1, the virtual switch S2, the security domain 1 and the security domain 2 as described above are used as an example. Since S1 is included in the security domain 1 and S2 is included in the security domain 2, a security policy table that is generated is shown in Table 3 as follows:

TABLE 3
Table generated using implementation solutions of the present disclosure

| Host Computer/Device | Security domain |
|---|---|
| S1 | 1 |
| S2 | 2 |

As can be seen from a comparison between Table 1 and Table 3, a security policy table generated by the embodiments of the present disclosure can merely include two items: a host computer/device, and a security domain. Apparently, Table 1 and Table 3 as described above are merely illustrative. A specific process of implementation in practice may include other items, and fields. However, if each virtual switch is within rule limitations and a virtual dedicated network includes N virtual switches, a security policy table of an existing virtual dedicated network may include corresponding N (or N+L, with L being much less than N) table items. Each virtual switch can connect with a number of switching nodes. Specifically, in a virtual dedicated network having a large number of host computers, the number of virtual switches is usually much less than the number of switching nodes. For example, there may be one million of switching nodes, and the one million of nodes are connected to one hundred virtual switches. In this case, table items in a security policy table are only one hundred, and a number thereof is significantly less as compared to one million. As can be seen, the security policy table that is generated using the embodiments provided in the present disclosure can have substantially less number of table items as compared with existing ways of using IP or host computers, thereby greatly reducing an amount of data in rule tables and effectively improving the response speed and entire performance of a system.

The method of generating rule tables for a virtual dedicated network provided in the present disclosure can configure and generate a variety of rule tables such as a security policy table and a routing table for virtual switches. The number of table items in the variety of rule tables can be greatly reduced because the number of virtual switches is generally much less than the number of switching nodes (e.g., host computers in a network). As such, since the number of table items in the rule tables is greatly reduced, the number of table items processed by switching (transfer) nodes is thus reduced. Therefore, the speeds of updates and queries are increased, and the entire throughput is increased, thereby improving the performance of a system and reducing the complexity of the system. For node management and control, a number of updates and downloads are apparently reduced, and thereby the system can easily support a tremendous number of users. The capacity of the system is also easily expanded and increased. By using embodiments of the present disclosure for generating rule tables, the consumption of resources can be effectively reduced, and the performance and the usage experience of a network is improved. Moreover, the costs for managing and maintaining security policy tables can also be reduced.

Apparently, the method described in the present disclosure is suitable for a variety of different types of rule tables of a virtual dedicated network. In implementations, the rule table may include at least one of a security policy table, a routing table, or a network address translation table.

In implementations, configuring and generating the rule table for the virtual dedicated network using the network identifier of the virtual switch as the keyword may include the following operation.

S1042 obtains an identifier of a security domain to which a host computer in a subnet that corresponds to the virtual switch belongs in response to the rule table including a security policy table, and configures the security policy table based on the identifier of the security domain and the network identifier of the virtual switch.

A security policy table that is generated using the embodiments of the present disclosure can be represented by Table 3. In general, the security policy table may include at least two fields. One field is a host computer/device, i.e., a name field (network identifier) of a virtual switch. Another field is a name field of a security domain, i.e., a network identifier of the security domain. When configuring the security policy table, identifiers of security domains of host computers in various subnets in a virtual dedicated network can be obtained. In general, all host computers in a subnet can be configured to belong to a security domain. In this way, a security policy table can be generated and information of various security domains can be configured by corresponding network identifiers of virtual switches that correspond to a subnet with identifiers of security domains of all the host computers in the subnet. The security policy table that is generated may include two table items. One table item is a security domain 1 to which a virtual switch S1 corresponds (or belongs). Another table item is a security domain 2 to which a virtual switch S2 corresponds (or belongs). An example of all host computers under each virtual switch is shown in Table 3. A1, A2 and A3 under S1 belong to the security domain 1.

Apparently, when a new virtual switch S3 is added, the virtual switch is allocated into a subnet 3 if the virtual switch joins a new security domain 3. The security domain 3 is obtained by configuring an access control policy for Group 3. The security policy table as shown in Table is then updated, and an updated security policy table is represented by Table 4:

TABLE 4
Table generated using implementation solutions of the present disclosure

| Host Computer/Device | Security domain |
|---|---|
| S1 | 1 |
| S2 | 2 |
| S3 | 3 |

In implementations, configuring and generating the rule table for the virtual dedicated network using the network identifier of the virtual switch as the keyword may include the following operation.

S1044 configures a routing table using a network identifier of a virtual switch of a subnet in which the target host computer that is to be jumped into is located as a keyword for routing when the rule table includes the routing table.

A routing table can be generated based on routing policies and virtual switches corresponding to the routing policies. The routing table includes virtual switches and routing policies corresponding to the virtual switches. Similarly, the virtual switch S2 and the above routing policy are used as an example. A routing table that is generated therefrom is represented by Table 5.

TABLE 5
Routing table generated using implementation
solutions of the present disclosure

| Host Computer/Device | Action |
|---|---|
| S2 | Routing |

Routing in a table item indicates that the virtual switch S2 adopts the above routing policy. An action “routing” in the table may be configured with actual routing and jumping information based on the routing policy of the virtual switch. For instance, example routing information may be information of routing and jumping from the current virtual switch S2 to a next virtual switch S20.

It can be understood that table items can be added when new virtual switches S3 and S4 using the above routing policy are added, as represented by Table 6.

TABLE 6
Routing table generated using implementation
solutions of the present disclosure

| Host Computer/Device | Action |
|---|---|
| S2 | Routing |
| S3 | Routing |
| S4 | Routing |

The routing table generated using the present embodiment includes very few table items thus greatly reducing an amount of data of the routing table.

In implementations, configuring and generating the rule table for the virtual dedicated network using the network identifier of the virtual switch as the keyword may include the following operation.

S1046 configures an address translation table using the network identifier of the virtual switch as a keyword for a corresponding subnet to perform a network address translation when the rule table includes the address translation table.

In implementations, port conversion policies can be configured for some or all of one or more virtual switches.

The virtual switch S1 is used as an example. If a type of port conversion policy that is configured is as follows:

S1 Access Internet do NAT.

This indicates that the virtual switch needs to perform a port conversion when accessing the Internet, and NAT represents a port conversion policy.

A port conversion table is generated based on port conversion policies and respective virtual switches corresponding to the port conversion policies. The port conversion policy includes the respective virtual switches and the port conversion policies corresponding to the respective virtual switches.

The virtual switch S1 and the above routing policy are used as an example. A port conversion table that is generated is represented by Table 7.

TABLE 7
Address translation table generated using
implementation solutions of the present disclosure

| Host Computer/Device | Action |
|---|---|
| S1 | Address translation |

The address translation in a table item indicates that the virtual switch S1 adopts the above address translation to implement network address translations between different subnets and between a subnet and a public network.

It can be understood that table items can be added when new virtual switches, such as S3 and S4, which use the above routing policy, are added, as represented by Table 8.

TABLE 8
Address translation table generated using
implementation solutions of the present disclosure

| Host Computer/Device | Action |
|---|---|
| S1 | Address translation |
| S3 | Address translation |
| S4 | Address translation |

The method of generating a rule table for a virtual dedicated network according to the present disclosure can create a port conversion table for a virtual switch in the network. Since the number of virtual switches is generally much less than the number of network host computers, the number of table items in the port conversion table is greatly reduced in an effective way. As such, when the port conversion table is used, the consumption of resources can be reduced, and the network performance can be improved, thereby enhancing the network usage experience and reducing the management and maintenance costs of the port conversion table.

The foregoing exemplary method can be implemented in a computer readable storage media executable by a computer. Specifically, the present disclosure further provides a type of computer readable storage media which stores computer instructions. When the computer instructions are executed, the following operations are implemented: determining virtual switches which act as switching nodes in a virtual dedicated network based on topological structure information of the virtual dedicated network; and using network identifiers of the virtual switches as keywords to configure and generate rule tables of the virtual dedicated network, the rule tables including at least the keywords which act as addresses of the switching nodes in the rule tables.

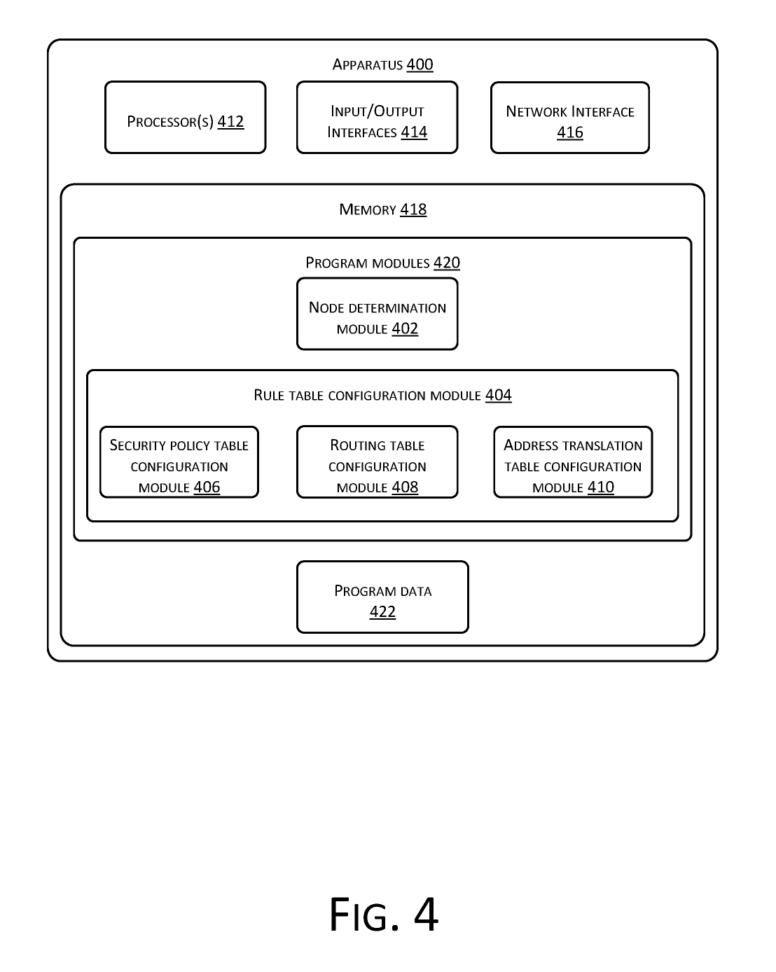

Based on the foregoing method of generating a rule table for a virtual dedicated network, the present disclosure further provides an apparatus of generating a rule table for a virtual dedicated network. FIG. 4 is a schematic diagram of a modular structure of an apparatus 400 of generating a rule table for a virtual dedicated network. As shown in FIG. 4, the apparatus 400 may include a node determination module 402 used for determining virtual switches which act as switching nodes in a virtual dedicated network based on topological structure information of the virtual dedicated network; and a rule table configuration module 404 used for using network identifiers of the virtual switches as keywords to configure and generate rule table(s) of the virtual dedicated network, the rule table(s) including at least the keywords which act as addresses of the switching nodes in the rule tables.

In implementations, the rule table(s) may include at least one of a security policy table, a routing table, or a network address translation table.

Different rule tables can have different configurations in different virtual dedicated networks. In implementations, the rule table configuration module 404 may include a security policy table configuration module 406, which may be used for obtaining an identifier of a security domain to which a host computer in a subnet that corresponds to the virtual switch belongs in response to the rule table(s) including a security policy table, and configuring the security policy table based on the identifier of the security domain and the network identifier of the virtual switch.

In implementations, the rule table configuration module 404 may include a routing table configuration module 408, which may be used for configuring a routing table using a network identifier of a virtual switch of a subnet in which the target host computer that is to be jumped into is located as a keyword for routing in response to the rule table(s) including the routing table.

In implementations, the rule table configuration module 404 may include an address translation table configuration module 410, which may be used for configuring an address translation table using the network identifier of the virtual switch as a keyword for a corresponding subnet to perform a network address translation in response to the rule table(s) including the address translation table.

In implementations, the apparatus 400 may further include one or more processors 412, an input/output (I/O) interface 414, a network interface 416, and memory 418.

The memory 418 may include a form of computer readable media such as a volatile memory, a random access memory (RAM) and/or a non-volatile memory, for example, a read-only memory (ROM) or a flash RAM. The memory 418 is an example of a computer readable media.

The computer readable media may include a volatile or non-volatile type, a removable or non-removable media, which may achieve storage of information using any method or technology. The information may include a computer readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 418 may include program modules 420 and program data 422. The program modules 420 may include one or more of the modules described in the foregoing description.

Details of implementations of the routing table, the security policy table and the address translation table that are involved in the apparatus provided in the above embodiment can be referenced to the description of related portions of the method embodiment, and are not repeatedly described herein.

The apparatus of generating rule tables for a virtual dedicated network provided in the present disclosure can configure and generate a variety of rule tables such as a security policy table and a routing table for virtual switches. The number of table items in the variety of rule tables can be greatly reduced because the number of virtual switches is generally much less than the number of switching nodes (e.g., host computers in a network). As such, since the number of table items in the rule tables is greatly reduced, the number of table items processed by switching (transfer) nodes is thus reduced. Therefore, the speeds of updates and queries are increased, and the entire throughput is increased, thereby improving the performance of a system and reducing the complexity of the system. For node management and control, a number of updates and downloads are apparently reduced, and thereby the system can easily support a tremendous number of users. The capacity of the system is also easily expanded and increased. By using embodiments of the present disclosure for generating rule tables, the consumption of resources can be effectively reduced, and the performance and the usage experience of a network is improved. Moreover, the costs for managing and maintaining security policy tables can also be reduced.

In the above rule tables generated in the present disclosure, virtual switches are used as keywords for configuring routing and transmission policies of messages. The number of table items of a routing table that is generated based on these routing and transmission policies is greatly reduced. The consumption of resources is reduced, while secure matchings for messages can be quickly performed in a virtual dedicated network in practice, thus improving the performance of transmission, management and control of the messages associated with switching nodes of the entire virtual dedicated network. Therefore, by making use of the solution of generating the above rule tables in the present disclosure, the present disclosure further provides a routing method for a virtual dedicated network. In implementations, the method may include analyzing a network message that is received, determining a target host computer to which the network message is jumped, and obtaining a target host computer identifier of a virtual switch corresponding to the target host computer; querying a routing address of a virtual switch that is next to be jumped into in a route towards the target host computer from a routing rule table based on the target network identifier, the routing rule table including at least the network identifier of the machine virtual switch that is used as the routing address configured and generated in the routing rule table; and sending the network message to the virtual switch that is next to be jumped into based on the routing address.

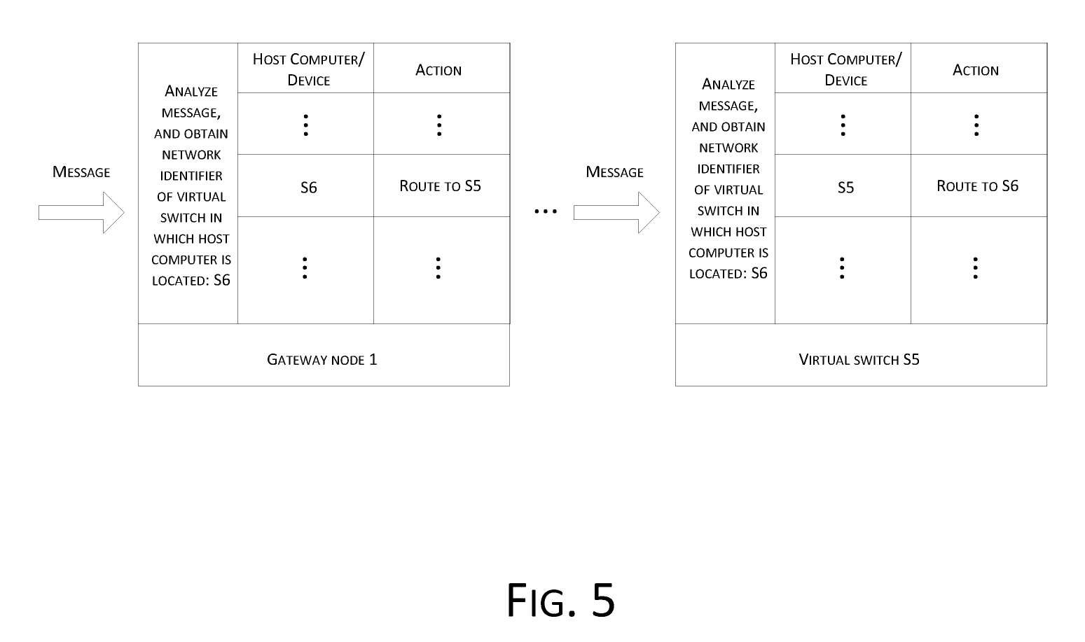

In response to receiving a network message, a virtual switch may analyze information in the network message that is received, and determine a target host computer that the network message is to reach. In implementation solutions of the present disclosure, host computers that are under a same virtual switch are configured with a network identifier of the same virtual switch in a routing table. A target network identifier of a next virtual switch to which the network message needs to be routed from a current switching node can be determined from the network message. A virtual dedicated network can set a switching node in which each virtual switch is located and a routing rule table that includes switching nodes of a network to use rule table(s) that is/are generated by the method or apparatus of the above embodiments of the present disclosure. As such, a current switching node can query a routing address of a next-jump virtual switch that routes towards the target host computer from the routing rule table based on the target network identifier, and send the network message to the next-jump virtual switch based on the routing address. A specific example is shown in FIG. 5. FIG. 5 is a schematic diagram of transmitting a message in a virtual dedicated network using a virtual switch as a keyword in according to the present disclosure. As shown in FIG. 5, after analyzing a message that is received, a current gateway node 1 learns that a target host computer of the message is located in a subnet 6, and a virtual switch corresponding to the subnet 6 is S6. A routing table configured by the gateway node 1 is configured with configuration information about a next jump in a route of transmitting the message with the target host computer in the subnet 6 to the virtual switch 6, i.e., first transmitting to a virtual switch S5 in the figure. Furthermore, the virtual switch S5 receives the message and after analysis, learns that the target host computer is located in the subnet 6. A routing table of S5 is configured with configuration information about adjusting a route to S6. In this case, the virtual switch S5 can directly transmit the message to the virtual switch S6.

Using the routing method of the present embodiment, a conventional routing table that simply uses IP addresses and host computers as routing index keywords can be modified into one that can use virtual switches as indices of next jump addresses, thus implementing a routing rule table that uses virtual switches of a subnet in a virtual dedicated network as jumping nodes. Therefore, after the routing method of the present disclosure transmits the network message to a virtual switch corresponding to a subnet in which the target host computer is located using the routing rule table when routing data is processed, the virtual switch transmits the network message to the target host computer based on a stored routing table associated with host computers.

If routing reaches the virtual switch in which the target host computer is located, a jump to the target host computer can be made based on a rule table internal to the subnet. In general, a subnet includes multiple host computers. A routing table associated with host computers in a subnet can be configured in a virtual switch of the subnet for routing policies of the host computers, thus implementing routing transmission or data interactions with other subnets or public networks. Compared with existing approaches, a routing approach and a policy of a routing rule table generated by the foregoing method can truly implement management of a virtual dedicated network with subnets as node units. An increase or decrease in the number of host computers in a single subnet does not even affect a current routing rule table, and thus no update is needed. This greatly improves the rule table, while the performance of transfer nodes and management and control nodes is greatly improved.

The above routing method can be implemented in a computer readable storage media executable by a computer. When the computer instructions are executed, the effects of the present disclosure can be implemented. Specifically, the present disclosure further provides a type of computer readable storage media which stores computer instructions. When the computer instructions are executed, the following operations are implemented: analyzing a network message that is received, determining a target host computer to which the network message is jumped, and obtaining a target host computer identifier of a virtual switch corresponding to the target host computer; querying a routing address of a virtual switch that is next to be jumped into in a route towards the target host computer from a routing rule table based on the target network identifier, the routing rule table including at least the network identifier of the machine virtual switch that is used as the routing address configured and generated in the routing rule table; and sending the network message to the virtual switch that is next to be jumped into based on the routing address.

The method or apparatus of generating a rule table for a virtual dedicated network provided by the present disclosure can be used in virtual dedicated networks, and can greatly reduce the number of table items in rule tables of the virtual dedicated networks, and reduce table items of transfer nodes and an amount of data of management and control nodes. The entire system performance is improved, and the system complexity is reduced, thus being able to solve the scaling, performance and capacity problems of a virtual dedicated network having a tremendous number of users effectively. Therefore, the present disclosure further provides a virtual dedicated network. The network includes at least virtual switches, subnets that use the virtual switches as switching nodes, and rule tables that store configuration and processing policies of the virtual dedicated network. The rule tables are configured to be generated by using the foregoing method of generating rule tables for a virtual dedicated network, or generated by the foregoing apparatus of generating rule tables for a virtual dedicated network.

Although the present disclosure describes concepts of virtual switches and switching nodes routing or address translation methods, data routing methods such as security policy configuration design methods in VPCs, concept definitions, information exchange/processing, etc., the present disclosure is not limited and necessary to comply with industry communication standards, standard VPC rules, or conditions described in the embodiments. Certain industry standards or implementation solutions with slight modifications based on the implementations described in the embodiments can also achieve identical, equivalent or similar to the above embodiments, or predictable implementation effects after changes. Embodiments obtained by applying these modified or changed data definitions, routing methods, security policy groupings, and data processing methods, etc., may still fall within the scope of optional implementations of the present disclosure.

Although the present disclosure provides method operations as described in the embodiments or flowcharts, more or fewer operations may be included based on conventional or non-creative means. The order of operations listed in the embodiments is only one of the many orders of execution and does not mean to be the only order of execution. When an actual apparatus or terminal product is executed, an execution can be performed sequentially or in parallel according to the order described in a method of an embodiment or figure (e.g., in parallel processor or multi-threaded environment, even for distributed data processing environments). Moreover, terms “comprising”, “including” or any other variation thereof, are intended to cover a non-exclusive inclusion, such that a series of elements including the process, method, article or device include not only those elements, but also include other elements not expressly listed, or inherent elements included in the process, method, article, or device. In the absence of more restrictions, the process, method, article, or device include the elements does not exclude an existence of additional identical or equivalent elements.

The units, apparatuses or modules, etc. described in the above embodiments may be implemented by a computer chip or an entity, or a product having certain functionalities. For the sake of description, when the above apparatuses are described, the functions are divided into various modules and described separately. Apparently, the functions of the modules can be implemented in one or more software and/or hardware components. A module realizing a function may also be implemented by a combination of multiple sub-modules or sub-units. The implementations of the apparatuses described above are merely illustrative. For example, a division of units are just for a logical division of functions. Another way of division can exist in an actual implementation. For example, a plurality of units or components may be combined or may be integrated into another system, or some features can be ignored, or not executed. Further, communication connections involved in the implementations of the methods, apparatuses or electronic devices may be connected via interfaces, indirect coupling or communication connections between devices or units, which may be electrical, mechanical or another form.

One skilled in the art also knows that other than implementing a controller through pure computer readable program codes, logic programming of the methods may be performed to implement the same functionalities using a way such as controlling logic gates, switches, application specific integrated circuits, programmable logic controllers, and embedded microcontrollers. Therefore, this type of controller may be considered to be a hardware component, and an internally included apparatus that is used for implementing various functions can be considered as a structure internal to the hardware component. Alternatively, an apparatus implementing various functions may even be considered as software module(s) or may be a structure internal to a hardware component.

The present disclosure may be described in the general context of computer-executable instructions executed by a computer, such as program modules. In general, program modules include routines, programs, objects, components, data structures, etc., that perform specific tasks or implement specific abstract data types. The embodiments of the present disclosure may also be implemented in distributed computing environments. In these distributed computing environments, tasks are performed by a remote processing device connected via a communication network. In a distributed computing environment, the program modules may be located in local and remote computer storage media, including storage devices.

As can be seen from the above description of the embodiments, one skilled in the art can clearly understand that the present disclosure can be implemented using software with necessary universal hardware platform. Based on this understanding, the essence of the technical solutions of the present disclosure or the portions that provide contributions to the existing technologies can be implemented in a form of a software product. The computer software product can be stored in a storage media, such as ROM/RAM, a magnetic disk, an optical drive, etc., which includes instructions to cause a computing device (which may be a personal computer, a mobile terminal, a server, or a network device, etc.) to perform certain portions of the method described in various embodiments of the present disclosure.

The embodiments of the present disclosure are described in a progressive manner. Same or similar portions of the embodiments can be referenced with each other. Emphasis of each embodiment is different from other embodiments. The present disclosure can be used in multiple universal or dedicated computing system environments or configurations, such as a personal computer, a server computer, a handheld device or portable device, a tablet device, a multi-processor system, a microprocessor-based system, a set-top box, a programmable electronic device, a network PC, a mini-computer, a large-scale computer, and a distributed computing environment including any of the above systems or devices, etc.

Although the present disclosure is described using exemplary embodiments, one of ordinary skill in the art can understand that the present disclosure has a variety of modifications and changes without departing the spirit of the present disclosure. The appended claims are intended to cover these modifications and changes that do not depart from the spirit of the present disclosure.

What is claimed is:

1. A method comprising:
determining a virtual switch used as a switching node in a virtual dedicated network based on topological structure information of the virtual dedicated network; and
using a network identifier of the virtual switch as a keyword to configure and generate rule tables of the virtual dedicated network.

2. The method of claim 1, wherein the rule tables including at least the keyword which is used as an address of the switching node in the rule tables.

3. The method of claim 1, wherein the rule tables comprises at least one of a security policy table, a routing table or a network address translation table.

4. The method of claim 1, wherein using the network identifier of the virtual switch as the keyword to configure and generate rule tables of the virtual dedicated network comprises obtaining an identifier of a security domain to which a host computer in a subnet that corresponds to the virtual switch belongs in response to the rule tables including a security policy table, and configuring the security policy table based on the identifier of the security domain and the network identifier of the virtual switch.

5. The method of claim 1, wherein using the network identifier of the virtual switch as the keyword to configure and generate rule tables of the virtual dedicated network comprises using a network identifier of a virtual switch of a subnet in which a target host computer to be jumped is located as a keyword for configuring a routing table.

6. The method of claim 1, wherein using the network identifier of the virtual switch as the keyword to configure and generate rule tables of the virtual dedicated network comprises using the network identifier of the virtual switch as a keyword for a corresponding subnet to perform a network address translation in response to the rule tables including an address translation table.

7. The method of claim 1, further comprising:
analyzing a network message that is received to determine a target host computer to which the network message is jumped;
obtaining a target host computer identifier of a particular virtual switch corresponding to the target host computer;
querying a routing address of a virtual switch that is next to be jumped into in a route towards the target host computer from a routing rule table included in the rule tables based on the target network identifier.

8. The method of claim 7, further comprising sending the network message to the virtual switch that is next to be jumped into based on the routing address.

9. The method of claim 9, wherein the particular virtual switch corresponding to the target host computer sends the network message to the target host computer based on a stored host computer routing table after the network message is sent to the particular virtual switch corresponding to the target host computer based on the routing rule table.

10. One or more computer readable media storing executable instructions that, when executed by one or more processors, cause the one or more processors to perform acts comprising:
determining a virtual switch used as a switching node in a virtual dedicated network based on topological structure information of the virtual dedicated network; and
using a network identifier of the virtual switch as a keyword to configure and generate rule tables of the virtual dedicated network.

11. The one or more computer readable media of claim 10, wherein the rule tables including at least the keyword which is used as an address of the switching node in the rule tables.

12. The one or more computer readable media of claim 10, wherein the rule tables comprises at least one of a security policy table, a routing table or a network address translation table.

13. The one or more computer readable media of claim 10, wherein using the network identifier of the virtual switch as the keyword to configure and generate rule tables of the virtual dedicated network comprises obtaining an identifier of a security domain to which a host computer in a subnet that corresponds to the virtual switch belongs in response to the rule tables including a security policy table, and configuring the security policy table based on the identifier of the security domain and the network identifier of the virtual switch.

14. The one or more computer readable media of claim 10, wherein using the network identifier of the virtual switch as the keyword to configure and generate rule tables of the virtual dedicated network comprises using a network identifier of a virtual switch of a subnet in which a target host computer to be jumped is located as a keyword for configuring a routing table.

15. The one or more computer readable media of claim 10, wherein using the network identifier of the virtual switch as the keyword to configure and generate rule tables of the virtual dedicated network comprises using the network identifier of the virtual switch as a keyword for a corresponding subnet to perform a network address translation in response to the rule tables including an address translation table.

16. The one or more computer readable media of claim 10, the acts further comprising:
analyzing a network message that is received to determine a target host computer to which the network message is jumped;
obtaining a target host computer identifier of a particular virtual switch corresponding to the target host computer;
querying a routing address of a virtual switch that is next to be jumped into in a route towards the target host computer from a routing rule table included in the rule tables based on the target network identifier.

17. The one or more computer readable media of claim 16, the acts further comprising sending the network message to the virtual switch that is next to be jumped into based on the routing address.

18. The one or more computer readable media of claim 17, wherein the particular virtual switch corresponding to the target host computer sends the network message to the target host computer based on a stored host computer routing table after the network message is sent to the particular virtual switch corresponding to the target host computer based on the routing rule table.

19. A method comprising:
analyzing a network message that is received, determining a target host computer to which the network message is jumped, and obtaining a target host computer identifier of a virtual switch corresponding to the target host computer;
querying a routing address of a virtual switch that is next to be jumped into in a route towards the target host computer from a routing rule table based on the target network identifier, the routing rule table including at least the network identifier of the virtual switch that is used as the routing address configured and generated in the routing rule table; and
sending the network message to the virtual switch that is next to be jumped into based on the routing address.

20. The method of claim 19, wherein the virtual switch corresponding to the target host computer sends the network message to the target host computer based on a stored host computer routing table after the network message is sent to the virtual switch corresponding to the target host computer based on the routing rule table.
